(19) United States
(12) Patent Application Publication
(10) Pub. No.: US 2012/0091333 A1
(43) Pub. Date: Apr. 19, 2012

(54) DIAGNOSTIC METHOD

(76) Inventors: Peter William French, Balmain (AU); Dharmica April Harridatt Mistry, Jannali (AU); Joseph Haklani, Guildford (AU); Gary L. Corino, Curlewis (AU)

(21) Appl. No.: 13/377,094

(22) PCT Filed: Jun. 11, 2010
(86) PCT No.: PCT/AU10/00727

§ 371 Date: Dec. 8, 2011

(30) Foreign Application Priority Data
Jun. 12, 2009 (AU) 2009902730

(51) Int. Cl. G01N 30/00; G01N 30/06; H01J 49/26; G01N 30/90

(52) U.S. Cl. 250/282; 73/61.43; 73/61.54; 73/61.55; 73/23.41

(57) ABSTRACT

The present invention relates to methods to identify one or more conditions in a subject. In particular, it relates to methods of identifying a condition such as cancer, which changes a lipid profile in a keratin-containing component of a subject, the changes to the lipid profile being determined by techniques such as chromatography and mass spectrometry.

### FIELD OF THE INVENTION

The present invention relates to methods to identify one or more conditions in a subject. In a particular embodiment, it relates to methods of identifying a condition which changes a lipid profile in a keratin-containing component of a subject.

### BACKGROUND ART

Any discussion of the prior art throughout the specification should in no way be considered as an admission that such prior art is widely known or forms part of common general knowledge in the field.

Methods for early stage detection of disease in order to maximize treatment outcomes are clearly desirable. Cancer, and in particular breast cancer, is one example that clearly demonstrates excellent survival statistics when early-stage disease is treated using current therapies. However, for many patients diagnosis is made too late. If all cases of breast cancer could be detected prior to metastasis then there would be a significant reduction of both individual mortality and the economic burden on the community. One of the key imperatives in cancer research, including breast cancer research, therefore, is the need to develop more effective screening tools for the early detection of disease.

Biomarkers are biological molecules that are indicators of biological and pathological processes, or physiological and pharmacological responses to a drug treatment. Since biomarkers can be used to measure the progress of disease or the response to treatment, they have very significant potential roles to play in both the diagnosis and prognosis of disease. Ideally, in the case of breast cancer a biomarker signature would be able to detect cancer in asymptomatic patients and improve the accuracy of screening mammograms. A reliable biomarker signature may also signify new cancer, even in the setting of normal physical examination results, and would indicate further more intensive diagnostic workup and/or preventive treatment.

Reported differences in the small angle X-ray scattering (SAXS) patterns of hair from individuals with breast cancer compared to healthy subjects was reported in James et al 1999 (Nature 398: 33-34) and is the subject of WO 00/34774, the contents of which are herein incorporated by reference.

The SAXS patterns of hair from cancer patients contained a ring of comparatively low intensity which was superimposed on the normal a-keratin pattern obtained from healthy control subjects.

It has been reported that the results of James et al 1999 have been difficult to replicate. Trounova et al 2003 (X-ray Spectrometry 31: 314-318) noted that at least five teams were unable to find a correlation between the presence of a ring and the clinical state of patients. Further, Briki et al 1999 (Nature 400: 226) found that the ring was observed in all healthy subjects and only 80% of breast cancer patients.

As such, the precise nature of the ring seen on the SAXS pattern is unknown to date. Trounova et al 2003 concluded that the ring does not have a lipid nature and, instead, was due to calcification or heavy metal deposition.

It is an object of the present invention to overcome or ameliorate at least one of the disadvantages of the prior art, or to provide a useful alternative.

It is an object of the invention in its preferred form to provide an improved method to identify one or more conditions in a subject.

### SUMMARY OF THE INVENTION

According to a first aspect, the present invention provides a method of identifying a condition which changes a lipid profile in a keratin-containing component of a subject, the method including the steps of:
applying one or more extraction agents to the keratin-containing component to extract one or more lipids; and
identifying the one or more lipids,
   wherein the identity of the one or more lipids is indicative of a subject having the condition which changes the lipid profile in the keratin-containing component.

According to a second aspect, the present invention provides a method of identifying a condition which changes a lipid profile in a keratin-containing component of a subject, the method including the steps of:
applying one or more extraction agents to the keratin-containing component to extract one or more lipids; and
analysing the level of the one or more lipids;
   wherein the level of the one or more lipids compared to a predetermined standard is indicative of a subject having the condition which changes the lipid profile in the keratin-containing component.

According to a third aspect, the present invention provides a method of identifying a condition which changes a lipid profile in a keratin-containing component of a subject, the method including the steps of:
applying one or more extraction agents to the keratin-containing component to extract one or more lipids;
identifying the one or more lipids; and
analysing the level of the one or more lipids;
   wherein the identity and level of the one or more lipids compared to a predetermined standard is indicative of a subject having the condition which changes the lipid profile in the keratin-containing component.

According to a fourth aspect, the present invention provides a method of identifying cancer in a subject, the method including the steps of:
applying a mixture of methanol, chloroform and water to the hair to extract one or more lipids;
measuring the mass and level of the one or more lipids by mass spectrometry; and
identifying the one or more lipids,
   wherein the identity or level of the one or more lipids is indicative of cancer.

In one embodiment, the present invention provides a method of identifying a condition which changes a lipid profile in a keratin-containing component of a subject, said method including:

obtaining a keratin-containing sample from the subject;

applying one or more extraction agents to said sample to extract one or more lipids from the keratin containing sample; and

identifying the lipid;

wherein the identity of the extracted lipid or lipids are indicative of a subject having the condition which changes the lipid profile in said keratin-containing component.

In another embodiment, the present invention provides a method of identifying a condition which changes a lipid profile in a keratin-containing component of a subject, said method including:

obtaining a keratin-containing sample from the subject;

applying one or more extraction agents to said sample to extract one or more lipids from the keratin containing sample; and

analysing the level of said one or more lipids in said sample;

comparing the level of said one or more lipids to a control;

wherein the level of said one or more lipids in said sample being outside of the control is indicative of a subject having the condition which changes the lipid profile in said keratin-containing component.

The condition may comprise a neoplastic condition. The neoplastic condition may comprise a wide range of cancers and is not limited to a specific cancer, with the proviso that said cancer alters the lipid profile of the keratin. Examples of cancers include cancer of the breast, colon, lung, cervix, pancreas, stomach, vagina, oesophagus, kidney, ovary, duodenum, small intestine, rectum, salivary gland, or cecum.

In one embodiment the condition is a condition which results in an increase in the level of the one or more lipids compared to a predetermined standard. For example, the one or more lipids may be selected from lipids having mass 503.3176, 512.4602, 524.4594, 525.4528, 526.4751, 537.4822, 538.5113, 540.5266, 541.5297, 552.4901, 556.5215, 557.5250, 568.5560, 580.5202, 582.4656, 596.5884, 619.3451, 624.6197, 634.7441, 652.6506, 682.5185, 786.4917, 786.6695 and 850.5314.

In one embodiment the condition is a condition which results in a decrease in the level of the one or more lipids compared to a predetermined standard. For example, the one or more lipids may be selected from lipids having mass 508.4652, 510.3930, 510.4808, 511.4835, 524.4957, 534.4798, 536.4961, 549.4811, 550.4853, 554.4182, 555.5365, 574.5314, 581.5520, 582.4502, 583.5682, 598.4452, 616.5435, 618.5588, 619.5619, 626.4753, 643.4452, 646.5901, 670.5014, 707.6126, 715.5302, 723.5633 and 758.5524.

The condition may result in an alteration of the lipid profile in the keratin-containing component by a number of pathways. The condition may cause an alteration in the composition or in the normal metabolic pathways of one or more lipid species.

The one or more lipids which are extracted from the keratin containing sample and which are indicative of the condition, may be identified by a number of means including Thin Layer Chromatography (TLC). In a further embodiment, Mass Spectrometry (MS) is used to identify the extracted lipid. For specific lipids, probes may be constructed to bind to and identify the extracted lipid or lipids. Such probes include monoclonal antibodies specific antigens on a particular lipid(s).

The alteration in the lipid profile of the keratin-containing component may result from an alteration of any one or more of a number of lipids in the keratin. Examples include, but are not limited to: phospholipids including phosphatidylethanolamine, phosphatidylcholine, lysophosphatidylcholine, phosphatidylserine, phosphocholine; sphingolipids including sphingomyelin, sphingosine; palmitic acid, palmitoleic acid, arachidonic acid; linoleic acid and choline.

In one embodiment, the condition may alter normal phospholipid metabolism or composition in body tissues and/or fluids. In this embodiment, various metabolites in the phospholipid metabolism pathway may be altered. As an example, the metabolic pathway of choline may be altered to ultimately cause an altered composition or biosynthesis of choline phospholipids in a keratin-containing component.

In a further embodiment, the condition may cause a change in the profile of a fatty acid containing compound such as sebum in a keratin-containing component of the subject.

By “change in profile” it is to be understood that this term includes a number of embodiments. For example, the keratin-containing component may comprise one or more lipids not normally found in keratin-containing components of healthy subjects. Alternatively, the change in profile may comprise one or more lipids normally found in keratin of healthy subjects but wherein the level of lipid in the keratin is altered (i.e., it may be increased or decreased).

The keratin-containing component of the present invention may include, but is not limited to any type of body hair, nail, skin and cuticle. The keratin-containing sample may be taken from any of these components.

The extraction agent may be any agent which extracts lipids. For example, the extraction agent may be any organic solvent which solubilises lipids, or any combination of solvents. Examples include non-polar and polar solvents. Non-polar solvents include chloroform, hexane, toluene, benzene, diethyl ether and ethyl acetate. Polar solvents include methanol, ethanol, acetone, n-propanol, isopropanol, butanol, acetic acid, formic acid, dimethyl sulfoxide, dimethylformamide, acetonitrile, tetrahydrofuran and 1,4-dioxane. In one embodiment the extraction agent includes chloroform and methanol.

In one embodiment, the use of an extraction agent on the keratin-containing material from a subject extracts a lipid or lipids, the presence or the quantity of which is indicative of breast cancer. The means to identify the presence and/or quantity of lipids could be by any of a number of methods including but not limited to Thin Layer Chromatography, Mass Spectrometry, Gas Chromatography and High Performance Liquid Chromatography.

In an embodiment wherein the condition comprises breast cancer, the extracted lipid may be a phospholipid such as phosphatidylcholine, lysophosphatidylcholine, phosphocholine or phosphatidylethanolamine.

If the lipid profile of a keratin-containing sample is altered due to a subject suffering from a condition which alters this lipid profile, the use of a specific agent that extracts the lipid may provide a means to detect the condition earlier than by conventional means such as imaging by mammography, ultrasound or MRI.

In the context of the present invention, the term “lipid profile” refers to the characteristics of the one or more lipids extracted from the keratin-containing sample. For example, such characteristics may be the identity, mass, level, or retention time of the one or more lipids.

Lipids may be identified by any means. For example, lipids may be identified by comparing the masses of the lipids obtained by mass spectrometry to reference lipids.

In the context of the present invention, the term “predetermined standard” means the lipid level found in a corresponding keratin-containing component of a subject not having a condition which changes the lipid profile in the keratin-containing component.

The present invention provides an understanding of the underlying molecular cause of the ring seen on the SAXS pattern mentioned in James et al and provides an improved method for identifying a condition which changes a lipid profile in a keratin-containing component of a subject, such as breast cancer. This understanding and the findings set out in this invention also allow identification of conditions other than breast cancer.

### BRIEF DESCRIPTION OF THE DRAWINGS

FIG. 1 shows A) a normal X-ray diffraction pattern of hair and B) an abnormal X-ray diffraction pattern of hair;

FIG. 2 shows A) an X-ray diffraction pattern of a hair with no ring and B) the X-ray diffraction pattern following soaking of the hair of A) in olive oil;

FIG. 3 shows the effect of solvent on the X-ray diffraction pattern of a hair exhibiting a ring;

FIG. 4 shows enhancement of a ring observed from the results of X-ray diffraction by using lead nitrate.

FIG. 5 shows the total phosphatidylcholine/lysophosphatidylcholine extracted from hair samples from breast cancer patients and controls.

FIG. 6 shows the principal component analysis scores (A) and loadings (B) for lipids extracted from hair samples from breast cancer patients and controls.

FIG. 7 shows the partial least squares scores (A) and loadings (B) for lipids extracted from hair samples from breast cancer patients and controls.

FIG. 8 shows the masses and retention times of lipids elevated >2 fold in breast cancer patients (A) and elevated >2 fold in controls (B).

### DESCRIPTION OF AN EXEMPLARY EMBODIMENT OF THE INVENTION

Preferred embodiments of the invention will now be described, by way of example only.

Although the invention has been described with reference to specific examples, it will be appreciated by those skilled in the art that the invention may be embodied in many other forms.

### EXAMPLES

In the following described experimentation, the X-rays used are derived from synchrotron radiation or other monochromatic X-ray sources providing X-rays within the energy range of five to twenty-five keV.

Where the keratin-containing component studied was hair, a single hair was used. The hair was mounted on a holder under sufficient tension to maintain alignment. The holder was mounted on a motorised translation device capable of moving in 1 μm steps in the vertical and horizontal planes which enabled each sample to be precisely located in the X-ray beam. The hair fibres were mounted with the axis of the hair in the parallel plane and at a 90 degree angle of incidence to the X-ray source. The wavelength of the X-ray beam was approximately 1.1 Å and had a resolution (ΔE/E) of 1×10−4.

Each fibre was exposed to the X-ray source for a set period of time depending on the intensity of the beam. In general each sample was exposed to a total of approximately 1×10¹⁴ photons. The resultant diffraction patterns were collected on a MAR165 CCD detector. Sample to detector distance was approximately 600 mm.

### EXPERIMENTS

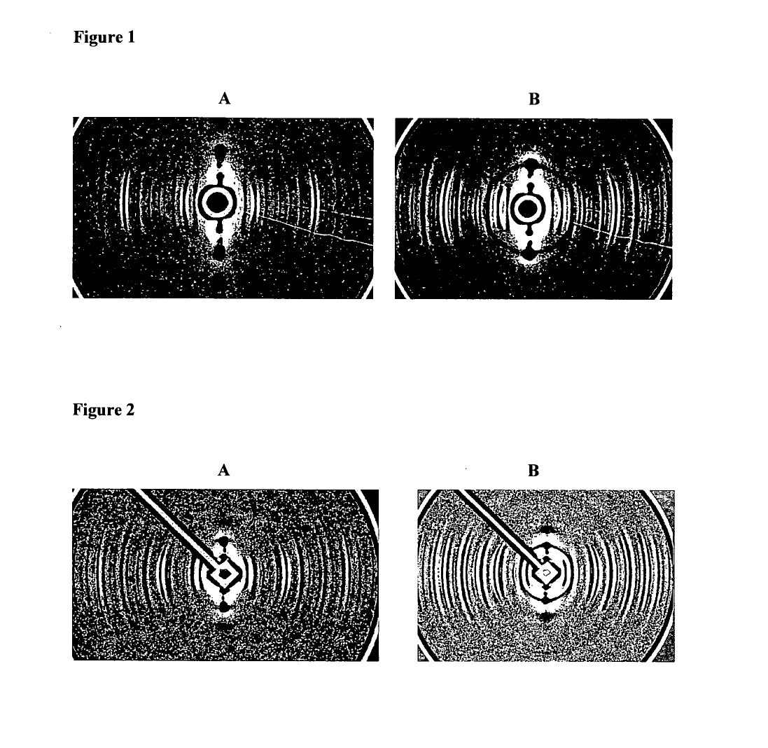

To determine that the ring found in a sample of hair from a breast cancer patient (as shown in FIG. 1B) is lipid-derived and, if so, to characterise the lipid.

From the applicant's previous studies, it is evident that certain conditions such as breast cancer, colon cancer and Alzheimer's disease result in the alteration of a keratin-containing component such as hair. This alteration may be detected using the X-ray diffraction technique outlined above. In patients suffering from breast cancer, a ring is observed. The diffraction pattern from a sample of hair from a healthy person is shown in FIG. 1A and from a breast cancer patient is shown in FIG. 1B. The ring reported to be associated with the presence of breast cancer can be seen in the diffraction pattern in FIG. 1B. To date, it has been unclear what causes this ring to appear. It has been speculated that it is due to an ‘additional component’ secreted from the breast cancer and taken up by the hair. The present invention addresses this by the finding that the ring is due to the presence of additional lipids or an increase in the amount of a particular lipid incorporated into the structure of keratin-containing components (see below).

### Experiment 1

### Addition of Fatty Acids to Hair

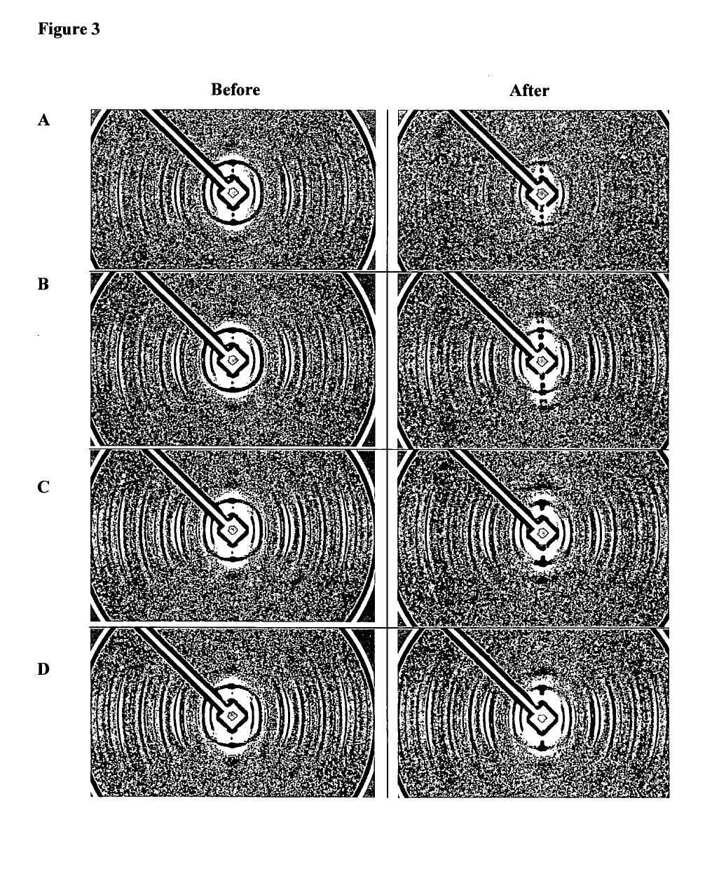

A sample of hair which did not have a ring (confirmed by X-ray diffraction) was selected. The diffraction pattern of this hair is shown in FIG. 2A.

The hair was then soaked in olive oil for 10 minutes, wiped dry and then re-exposed to X-rays. The resulting diffraction pattern is depicted in FIG. 2B wherein a clear ring is visible. The ring resulting from soaking in olive oil is very similar in appearance and d-spacing to the ring shown in FIG. 1B from a breast cancer patient.

### Experiment 2

### Solvent Extraction of Hairs

Hairs from breast cancer patients which displayed rings were run on a synchrotron SAXS beamline (Australian Synchrotron) to confirm the presence of the ring. The individual hairs were then soaked in a solvent for 2 hours, rinsed in MilliQ water, dried and then re-run very close to the same point on the hair fibre. The solvents used were:

### A Isopropanol (100%);

### B Chloroform (100%)

### C Chloroform/methanol (1:1);

### D Chloroform/methanol (1:2)

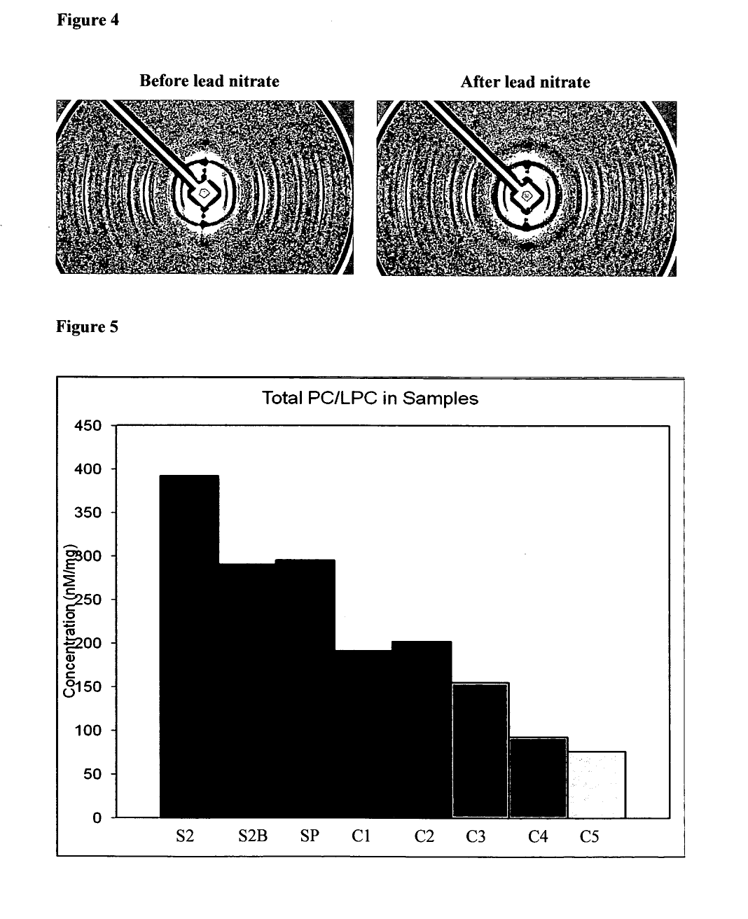

The results are shown in FIG. 3.

While all solvents reduced the intensity of the ring in most fibres, it was evident that consistently, isopropanol was the least effective and chloroform/methanol (1:2) was the most effective. This provided data to point to the species of lipid involved.

Particularly, chloroform/methanol in this ratio is used to extract neutral lipids, diacylglcerophospholipids and most sphingolipids from biological material with low lipid content.

### Experiment 3

### Enhancement of the Lipid Ring Using Lead Salts

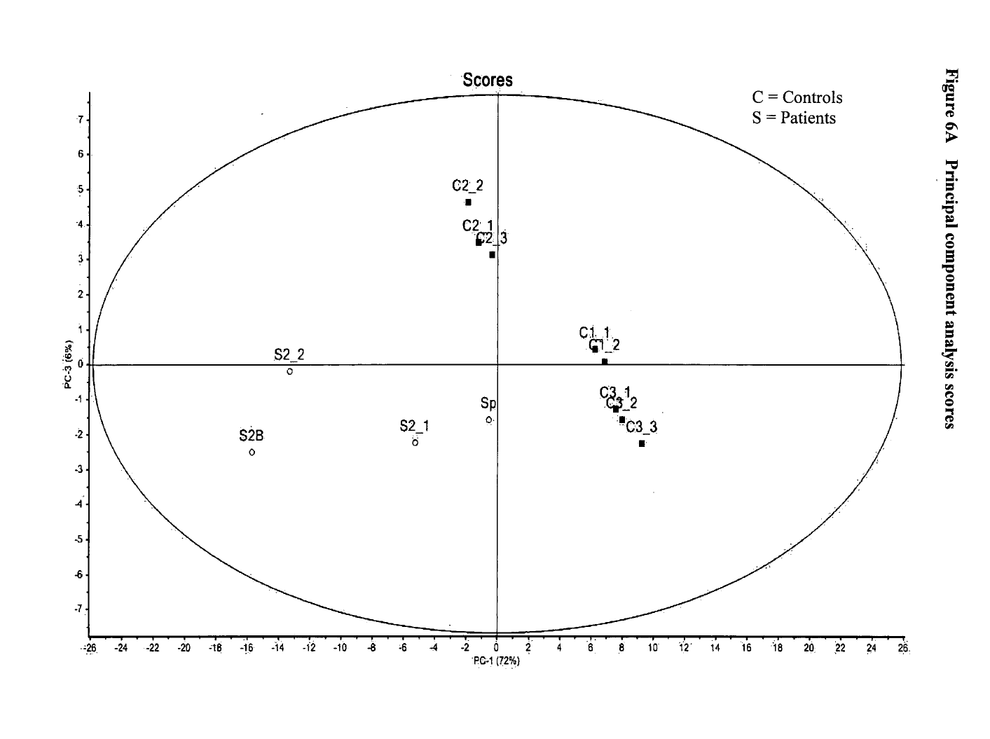

Hairs were soaked in 0.1 mol/l lead nitrate, at pH 5.8, at room temperature for 2 hours. Hairs were thoroughly washed in three successive 5 min immersions in MilliQ water, using the method of Bertrand et al (Bertrand L, Doucet J, Simionovici A, Tsoucaris G, Walter P, 2003. Lead revealed lipid organization in human hair BBA 1620: 218-224.). The results showed that the breast cancer ring was significantly enhanced in most cases. FIG. 4 shows the diffraction pattern of a sample hair before and after lipid enhancement by lead nitrate. The ring after enhancement is much stronger than that before exposure to the lead nitrate.

### Experiment 4

### Characterisation of Lipid Extracted from Hair

Samples used in this study were:
S2: pooled Patient Nos 11018 and 11019—stage 2 breast cancer (split into replicates S2-1 and S2-2)
S2B: pooled Patient Nos 11023 and 11010—stage 2B breast cancer
SP: pooled Patient Nos 11009, 11034 and 11029—stages 4, 2A and unknown respectively
Healthy controls C1 to C5 (C1 split into replicates C1-1 and C1-2, C2 split into replicates C2-1 to C2-3, and C3 split into replicates C3-1 to C3-2).

Hair samples were washed in acetone for 5-10 minutes. Dried samples were weighed into cryo-mill tubes and 1000 μL of extraction solution (methanol, chloroform, water (2:1:0.6)) was added into each tube. Samples were spiked with 10 μl of 100 μM internal standard (Cholesterol ester (18:0)d) to 10 μM final concentration. Hair was ground using a cryo-mill (Precellys) with 1.4 mm ceramic beads at 6800 rpm for three times of 30 seconds with 45 second between intervals and the samples were centrifuged for 10 minutes at 10000 rpm. Supernatant (500 μL) was transferred into eppendorf tubes and dried in speed-vac. Samples were resuspended in 100 μl of n-butanol and methanol (v/v1:1), centrifuged for 10 minutes at 10000 rpm and 50 μL of supernatant transferred to high-performance liquid chromatography (HPLC) vials for liquid chromatography mass spectrometry (LCMS) analysis.

Lipids were separated by injecting 5 μL aliquots onto a 50 mm×2.1 mm×2.7 μm Ascentis Express RP Amide column (Supelco) using an Agilent LC 1200. Lipid samples were eluted at 0.2 mLmin⁻¹ over a 5 min gradient of water/methanol/tetrahydrofuran (50:20:30, v/v/v) to water/methanol/tetrahydrofuran (5:20:75, v/v/v), with the final buffer held for 3 min. Lipids were analysed by electrospray ionisation-mass spectrometry (ESI-MS) using an Agilent Triple Quad 6460. The mass spectrometer in the positive mode was set to scan in precursor ion mode to identify phosphatidylcholines (precursors of m/z 184.1), sphingomyelins (precursors of m/z 184.1), ceramides (precursors of m/z 264.6), cholesterol esters precursors of (m/z 369.4), phosphatidylglycerols (precursors of m/z 189) and in the negative mode phosphatidylinositols (precursors of m/z 241). The mass spectrometer was set to scan in neutral loss mode to identify phosphatidylethanolamines (loss of m/z 141 in the positive ion mode) and phosphatidylserines (loss of m/z 87 in the negative ion mode). Multiple reaction monitoring (MRM) scans were used to quantify the identified lipids with the capillary voltage, fragmentor voltage, and collision energy were 4000 V, 140-380 V, and 15-60 V, respectively. In all cases, the collision gas was nitrogen at 7 Lmin⁻¹.

LCMS data was processed using Agilent MassHunter quantitative software and determined the mass and levels of the lipids extracted from the hair of breast cancer patients and healthy controls.

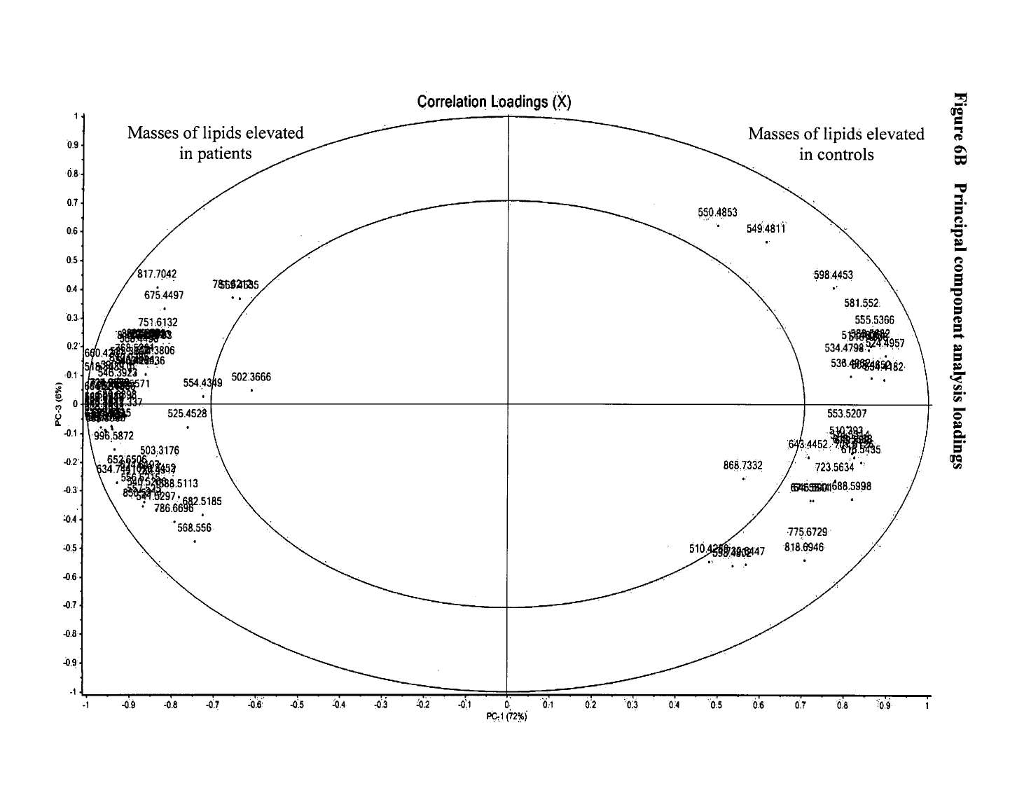

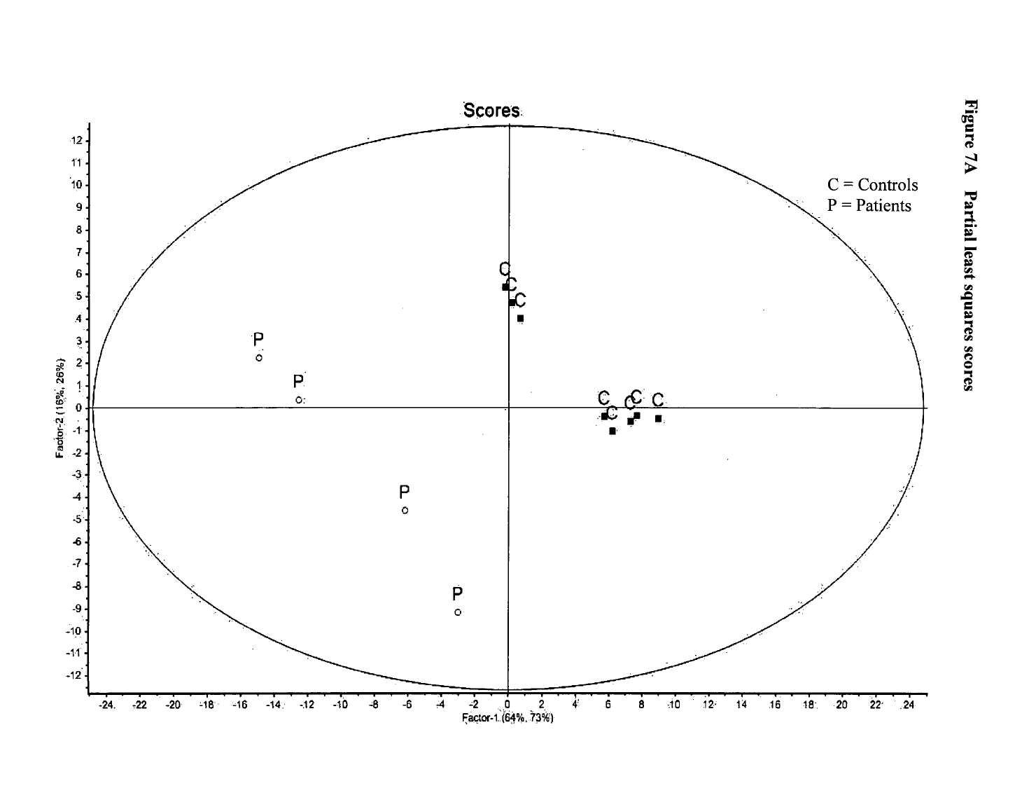

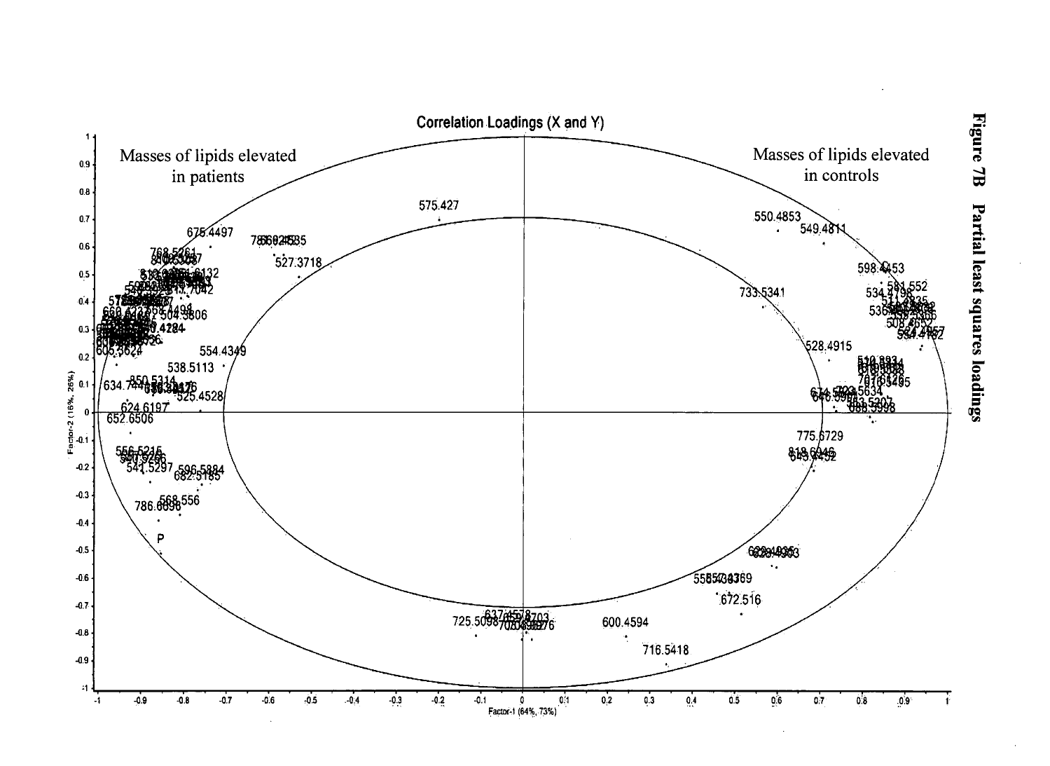

The results showed that the hair of breast cancer patients has higher levels of certain lipids (phosphatidylcholine/lysophosphatidylcholine) than the hair of healthy controls (FIG. 5). The principal component analysis scores plot (FIG. 6A) and partial least squares analysis scores plot (FIG. 7A) showed differences between the lipids extracted from the hair of breast cancer patients and the hair of healthy controls.

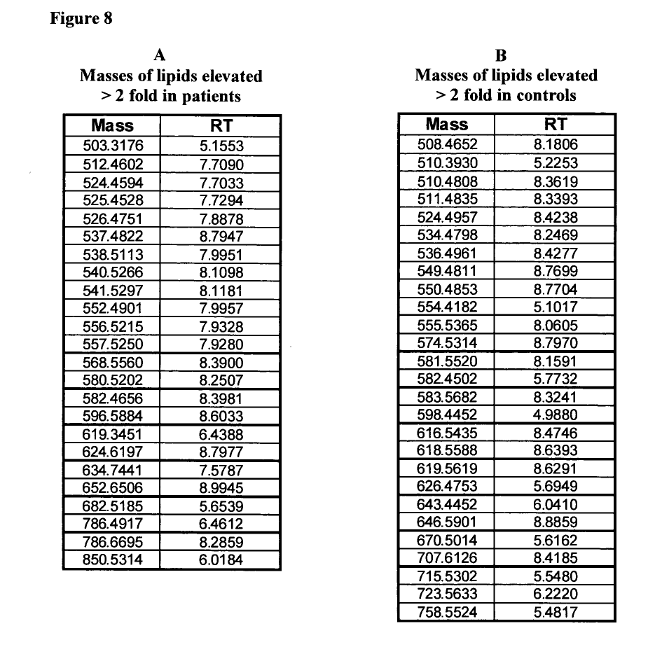

The principal component analysis loadings plot (FIG. 6B) and partial least squares analysis loadings plot (FIG. 7B) shows the masses of lipids elevated in breast cancer patients or healthy controls. The masses and retention times of lipids with a >2 fold increase in breast cancer patients or healthy controls are presented in FIG. 8.

### SUMMARY

The use of X-ray diffraction to establish the presence of an abnormality, in the form of a ring or halo, suggests that a patient from whom the sample is taken suffers from a condition which affects a keratin-containing component such as a hair. The present inventors have found that the associated ring in the pattern is due to a change in the lipid content of the keratin-containing component.

With this understanding, the inventors have found a method of testing hair for the presence of a component, being one or more lipids which is associated with a condition to thereby provide a reliable diagnostic tool in the early detection of conditions including breast cancer.

Characterisation of the identity and levels of lipids in keratin-containing components of subjects having a condition which changes the lipid profile in the keratin-containing component will enable the identification of lipid profiles that are indicative of diseases such as breast cancer.

1. A method of identifying a condition which changes a lipid profile in a keratin-containing component of a subject, the method including the steps of:
applying one or more extraction agents to the keratin-containing component to extract one or more lipids; and
identifying the one or more lipids,
wherein the identity of the one or more lipids is indicative of a subject having the condition which changes the lipid profile in the keratin-containing component.

2. A method of identifying a condition which changes a lipid profile in a keratin-containing component of a subject, the method including the steps of:
applying one or more extraction agents to the keratin-containing component to extract one or more lipids; and
analysing the level of the one or more lipids;
wherein the level of the one or more lipids compared to a predetermined standard is indicative of a subject having the condition which changes the lipid profile in the keratin-containing component.

3. A method of identifying a condition which changes a lipid profile in a keratin-containing component of a subject, the method including the steps of:
applying one or more extraction agents to the keratin-containing component to extract one or more lipids;
identifying the one or more lipids; and
analysing the level of the one or more lipids;
wherein the identity and level of the one or more lipids compared to a predetermined standard is indicative of a subject having the condition which changes the lipid profile in the keratin-containing component.

4. The method according to claim 1 wherein the condition is a neoplastic condition.

5. The method according to claim 4 wherein the neoplastic condition is cancer.

6. The method according to claim 5 wherein the cancer is selected from cancer of the breast, colon, lung, cervix, pancreas, stomach, vagina, oesophagus, kidney, ovary, duodenum, small intestine, rectum, salivary gland, and cecum.

7. The method according to claim 1 wherein the keratin-containing component is hair.

8. The method according to claim 1 wherein the extraction agent includes a polar solvent, a non-polar solvent, or a combination thereof.

9. The method according to claim 8 wherein the polar solvent is selected from the group consisting of methanol, ethanol, acetone, n-propanol, isopropanol, butanol, acetic acid, formic acid, dimethyl sulfoxide, dimethylformamide, acetonitrile, tetrahydrofuran and 1,4-dioxane.

10. The method according to claim 8 wherein the non-polar solvent is selected from the group consisting of chloroform, hexane, toluene, benzene, diethyl ether and ethyl acetate.

11. The method according to claim 8 wherein the extraction agent includes chloroform and methanol.

12. The method according to claim 1 wherein the identifying the one or more lipids is by thin layer chromatography, mass spectrometry, gas chromatography or high-performance liquid chromatography.

13. The method according to claim 12 wherein the one or more lipids is a phospholipid.

14. The method according to claim 13 wherein the phospholipid is selected from the group consisting of phosphatidylcholine, lysophosphatidylcholine, phosphocholine and phosphatidylethanolamine.

15. The method according to claim 2 wherein the analysing the level of the one or more lipids compared to a predetermined standard is by thin layer chromatography, mass spectrometry, gas chromatography or high-performance liquid chromatography.

16. The method according to claim 2 wherein the condition is a condition which results in an increase in the level of the one or more lipids compared to a predetermined standard.

17. The method according to claim 16 wherein the one or more lipids are selected from lipids having mass 503.3176, 512.4602, 524.4594, 525.4528, 526.4751, 537.4822, 538.5113, 540.5266, 541.5297, 552.4901, 556.5215, 557.5250, 568.5560, 580.5202, 582.4656, 596.5884, 619.3451, 624.6197, 634.7441, 652.6506, 682.5185, 786.4917, 786.6695 and 850.5314.

18. The method according to claim 2 wherein the condition is a condition which results in a decrease in the level of the one or more lipids compared to a predetermined standard.

19. The method according to claim 18 wherein the one or more lipids are selected from lipids having mass 508.4652, 510.3930, 510.4808, 511.4835, 524.4957, 534.4798, 536.4961, 549.4811, 550.4853, 554.4182, 555.5365, 574.5314, 581.5520, 582.4502, 583.5682, 598.4452, 616.5435, 618.5588, 619.5619, 626.4753, 643.4452, 646.5901, 670.5014, 707.6126, 715.5302, 723.5633 and 758.5524.

20. A method of identifying cancer in a subject, the method including the steps of:
applying a mixture of methanol, chloroform and water to the hair to extract one or more lipids;
measuring the mass and level of the one or more lipids by mass spectrometry; and
identifying the one or more lipids, wherein the identity or level of the one or more lipids is indicative of cancer.
